(19) United States
(12) Patent Application Publication
(10) Pub. No.: US 2017/0071194 A1
(43) Pub. Date: Mar. 16, 2017

(54) METHOD OF HYPOTHERMIC STORAGE AND SHIPPING OF STEM CELLS AND DIFFERENTIATED ORGAN STEM CELLS

(71) Applicant: StemoniX Inc., Eden Prairie, MN (US)

(72) Inventor: Robert John Petcavich, The Woodlands, TX (US)

(21) Appl. No.: 15/261,082

(22) Filed: Sep. 9, 2016

Related U.S. Application Data
(60) Provisional application No. 62/217,206, filed on Sep. 11, 2015.

(51) Int. Cl. A01N 1/02

(52) U.S. Cl. CPC A01N 1/0273; A01N 1/0284

(57) ABSTRACT

The present disclosure provides for the use of a temperature controlled shipping container as a method for the packaging and distribution of mammalian cells, e.g., in induced pluripotent stems cells (iPSc), and various organ cells differentiated from the iPSc. In one embodiment, a shipping box that utilizes a vacuum, desiccant and insulation construct is employed to package iPSc and their derivatives or progeny that are or have been deposited onto microwell plates or tubes that contain a nutrient solution during storage and shipping. The present system and method can maintain the cells in the containment vessels at or below 10° C. for at least 24 hours and in one embodiment up to 96 hours.

### CROSS-REFERENCE TO RELATED APPLICATIONS

This application claims the benefit of the filing date of U.S. application Ser. No. 62/217,206, filed on Sep. 11, 2015, the disclosure of which is incorporated by reference herein.

### TECHNICAL FIELD

The present disclosure relates generally to the field of stem cells and the hypothermic storage and distribution of those cells. More specifically, the present disclosure provides a method of maintaining the packaged cells at or below 10° C. for extended periods of time during worldwide shipping times and conditions.

### BACKGROUND

Early successes of cell therapy in applications such as the repair of diseased hearts, and treatment of Type 1 diabetes support the notion that the use of cells and tissues to treat disease states is one of the most promising avenues in contemporary medical treatment. In part, many cell therapy applications evolved indirectly from the launch of tissue engineering ventures that led to commercial development of engineered products such as skin and cartilage. Cell and tissue therapy has showcased its potential in medicine through recent clinical trials and is maturing under the new rubric of regenerative/reparative medicine.

The emergence of cell- and tissue-based technologies and the move toward a global marketplace are creating a demand for new technologies that allow worldwide shipment of such products while maintaining their viability or function, a concept referred to as biological packaging.

With the formation of worldwide shipping carriers such as FedEx and UPS, packages of all types can be shipped worldwide and delivered within 3 days. This transcontinental shipping requires hypothermic preservation solutions and packages that maintain viability and function of the cells following sequential storage intervals for transport that approach a week in duration.

The principles governing the development of effective biological packaging necessitate an understanding of state-of-the-art hypothermic storage and cryopreservation, the two standard approaches currently used for preserving cells and tissues for extended periods. Comparing and contrasting these two processes can initiate a dialog to define the challenges that each system must overcome to serve the future needs of the regenerative medicine market and the bioprocessing community at large. Hypothermic storage can be defined as the preservation of cells and tissues at chilled temperatures that often range from about 4° C. to about 10° C.; whereas cryopreservation can be defined as the storage of cells and tissues at subzero temperatures that typically range from about −80° C. to about −196° C.

A comparison is useful for determining which procedure is appropriate for a given therapeutic or bioprocessing application. For instance, if cells are to be shipped short distances or held in “stasis” before use, then hypothermic storage may be employed. That is the case with cellular therapy and in cases such as the on-demand use of cell plates for drug testing and toxicity screening.

Selection of an appropriate preservation regime depends on a number of factors, and time of storage is a key consideration. Other factors, including shipment method, in-house and end-user storage, and end use also can play a role in determining storage methodologies. Regardless of whether hypothermic storage or cryopreservation is the storage regime, formulation of the storage solution and the form factor utilized for containment are also variables to consider.

### SUMMARY

The present disclosure provides a method of hypothermic storage and shipping for cells, e.g., stem cells and differentiated organ stem cells, for global distribution. In one embodiment, the present disclosure is directed to a method of packaging and the distribution of living cells, in particular iPSc and differentiated iPSc such as cardiomyocytes, neurons, hepatocytes, as well as renal, islet, muscle skeletal, blood, and connective tissue, by means of a disposable hypothermic cooling box that utilizes no ice, or cryogenic materials, such as liquid nitrogen or solid carbon dioxide, and maintains a localized temperature in the storage area of from about 1° C. to about 10° C. In one embodiment, the present disclosure provides a method of transporting a living cell product that is subjected to conditions below ambient temperatures (and above freezing), thereby providing for cooling of the cell product from about 1 hour to about 120 hours. The method includes placing a living cell containing microplate array within the compartment defined by top, side and bottom walls, placing a sorption-cooling device in thermal communication with the compartment where the microplate array with cells is placed, activating the sorption cooling device, sealing the box to prevent accidental opening, and shipping the box from point A to point B anywhere on the globe. The cells in the box when they arrive at point B are viable, e.g., at least 30%, 40%, 50%, 60%, 70%, 80%, 90% or more the viability of corresponding cells before shipping, and, if they are stem cells, capable of differentiation at efficiencies similar to cells before shipping.

In one embodiment, a method of preparing living cells for packaging and distribution is provided. The method includes providing a receptacle having a compartment and a lid, wherein at least a portion of the compartment comprises an insulating material having a predefined thickness and predefined thermal conductivity which can maintain a temperature of about 1° C. to about 10° C. for at least 24 hours in the compartment. The lid may be part of the receptacle or may be independent of the receptacle. Also provided are a sorption device which comprises a passive heat absorbing material and a cell culture substrate having living cells in media. The cell culture substrate and the sorption-cooling device are placed in the compartment. The sorption-cooling device may be activated before or after placement into the compartment. The lid is then disposed over the compartment, and optionally the receptacle having the lid disposed thereon is sealed, to allow for a temperature of about 1° C. to about 10° C. for at least 24 hours in the compartment. In one embodiment, the cells are iPSc. In one embodiment, the cells are differentiated iPSc. In one embodiment, the insulating material can maintain a temperature of about 4° C. to about 10° C. for at least 24 hours. In one embodiment, the temperature is maintained for at least 96 hours. In one embodiment, the substrate is a multiwell plate. In one embodiment, the substrate with a lid so as to provide a water-proof barrier. In one embodiment, the compartment in the receptacle has a temperature of about 4° C. to about 10° C. 24 hours after sealing. In one embodiment, the compartment further comprises a temperature sensor. In one embodiment, the cells have a viability of at least 25% up to at least 90% 24 hours after sealing. In one embodiment,

the cells have a viability of at least 25% up to at least 90% 96 hours after sealing. In one embodiment, at least 25% up to at least 90% of the cells are capable of differentiation 24 to 96 hours after sealing.

### BRIEF DESCRIPTION OF THE DRAWINGS

FIG. 1 shows an example of a sorption box utilized in the present disclosure.

FIG. 2 shows an interior view of an exemplary sorption box of the present disclosure.

FIG. 3 shows an exemplary sorption module used in combination with the insulated box to enable hypothermic cooling.

FIG. 4 shows water loaded petri dishes used to simulate a biological load to be cooled.

FIG. 5 shows the cooling curves of the control thermometer outside the box and the thermometer temperature inside the storage compartment of the box 14 hours after activation.

FIG. 6 shows the temperature profile of a shipping box exposed to extreme outside temperature vs. ambient conditions.

FIG. 7 shows the temperature profile after 48 hours of activation.

FIG. 8 shows the temperature profile after 70 hours of activation.

FIG. 9 shows a cross sectional view of the cells loaded into a 384 microplate of the present disclosure that is loaded into the cooling chamber of the sorption box.

### DETAILED DESCRIPTION

The present disclosure provides for storage and shipping of living cells, in particular iPSc and cells differentiated from the iPSc, by the use of a package that does not use any ice, or cryogenic materials such as liquid nitrogen or frozen carbon dioxide, in a very small, easy to ship form for extended periods of time.

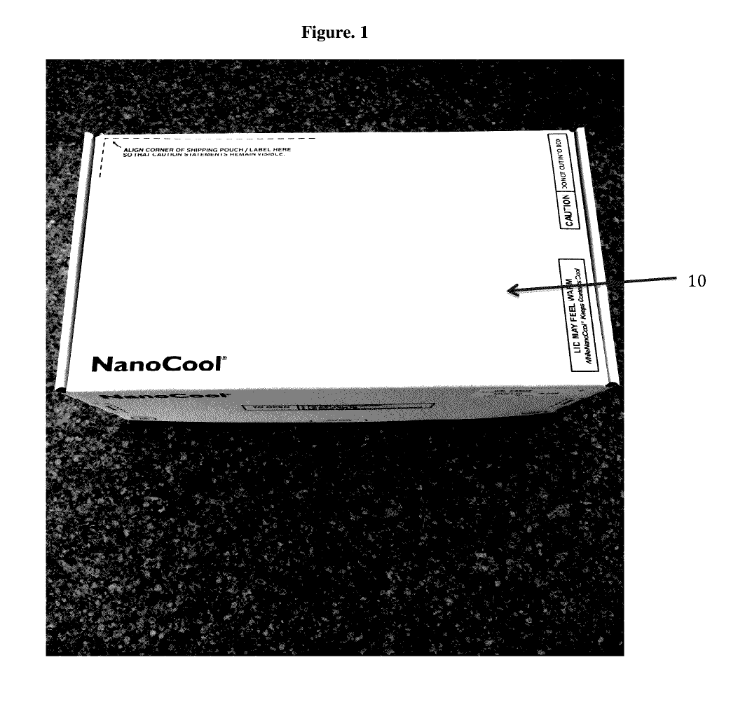

Referring to FIG. 1, this shows one example of a shipping device 10 useful in the present disclosure. It is a sorption-cooling device that can keep an internal insulated storage compartment contained within at a controlled temperature for extended periods of time. This device is described in U.S. Pat. Nos. 6,559,797, 6,688,132, 6,701,724, and 6,968,711, the disclosures of which are incorporated by reference herein. Other passive cooling devices, and other shipping devices that include insulating material, may be employed in the methods without departing from the scope of the disclosure. The details of the device theory and operation are described in detail in the aforementioned art and it is assumed that one skilled in the art would understand its operation and performance characteristics. In the present disclosure, the device is employed in packaging and shipping live mammalian cells, e.g., human iPSc and differentiated cells from the iPSc such as heart, brain, liver, kidney, pancreatic, connective tissue, skin, cartilage and blood cells to name a few.

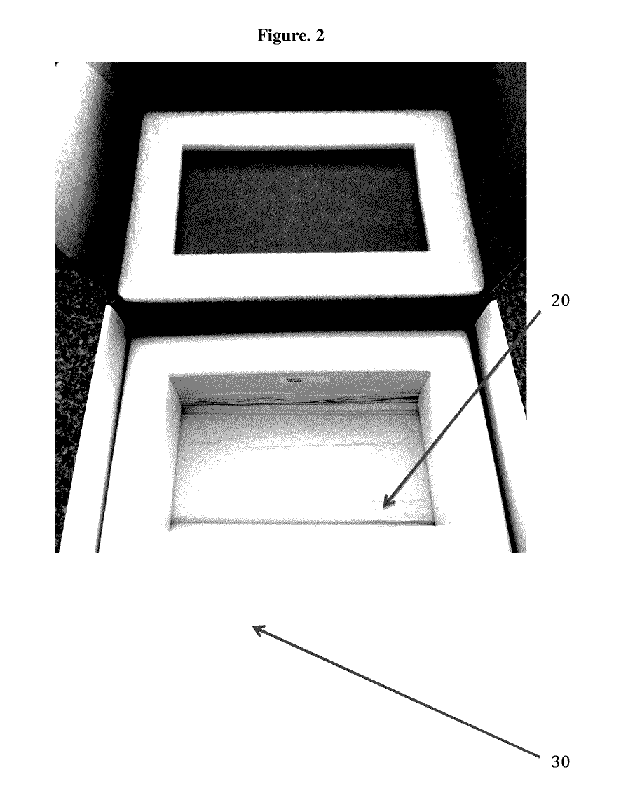

FIG. 2 shows the interior of the cooling package useful in the present disclosure. The exterior is a cardboard shell into which in the presence of insulation 20 forms an insulated compartment 30. The insulation 20 may be comprised of open and/or closed cell foam materials that are either formed of organic materials such as polymers or inorganic materials such as aerogels. The foam thickness and thermal conductivity determine the ultimate time that a biological material can be stored at hypothermic conditions.

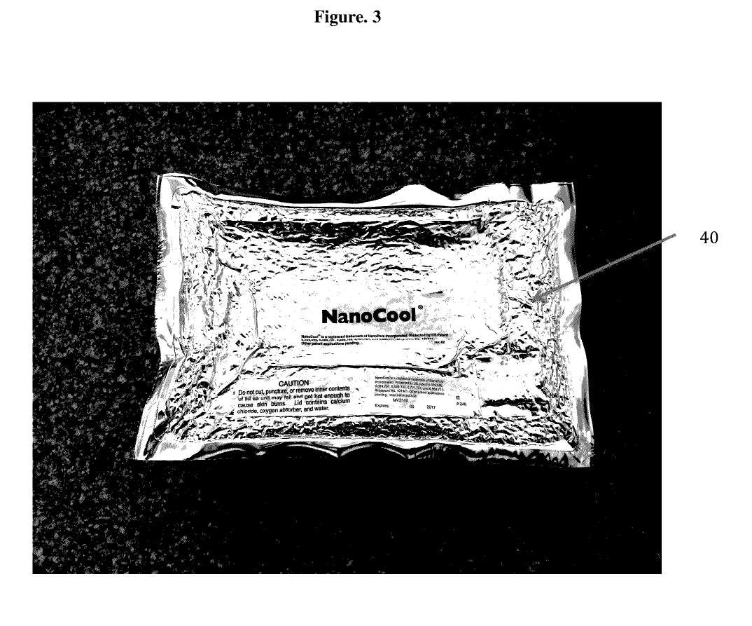

FIG. 3 show the sorption device 40 of the present disclosure, which is responsible for removing the heat in the storage compartment. The sorption device is a closed system where a liquid such as water is evaporated under vacuum and absorbed by a desiccant in the upper part of the chamber. This passive cooling engine can be sized accordingly to enable longer or shorter hypothermic cooling times based on the loading in the cooling chamber.

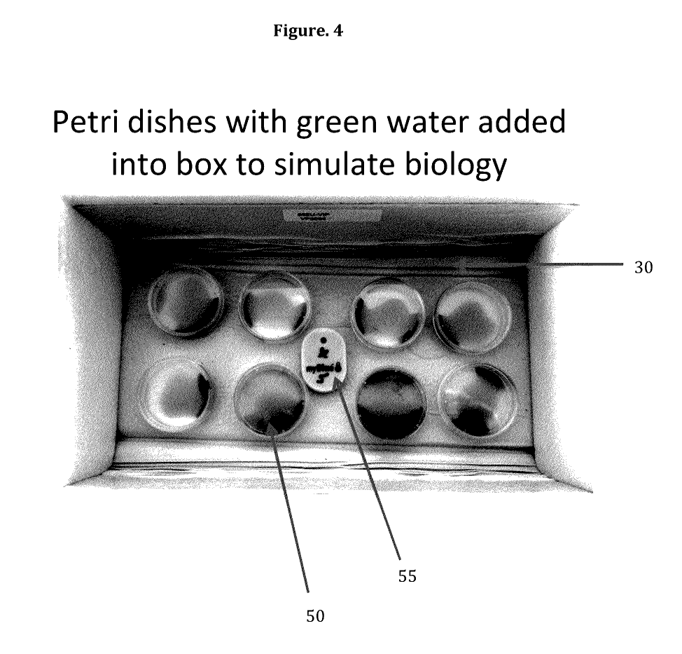

Referring to FIG. 4, this is an example of a hypothermic simulation of a biological loading into the cooling chamber 30 of the present disclosure. Into the cooling chamber 30 was loaded 8 petri dishes 50 each with 5 milliliters of water to mimic a biological sample. Also included into the cooling chamber was a wireless Bluetooth temperature sensor 55 to monitor the internal temperature with time. The sorption device 40 was activated and then positioned over the cooling chamber.

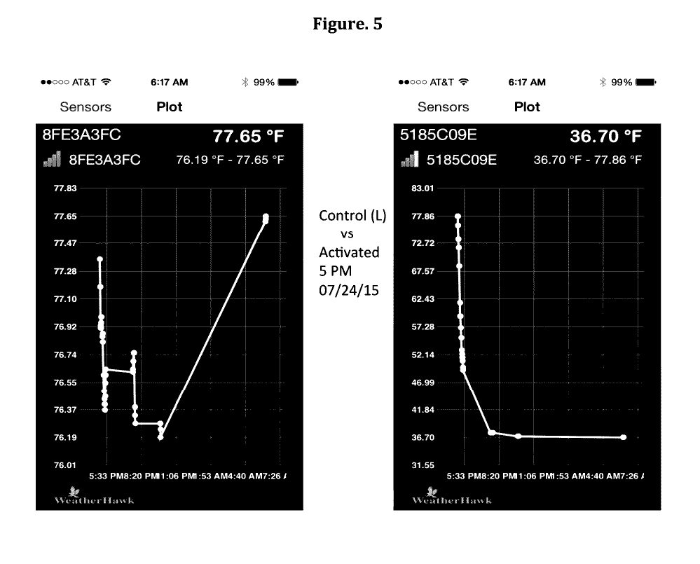

FIG. 5 shows a comparison of the ambient outside temperature on the left image vs. the inside temperature right hand image of the cooling device 77 minutes after activation of the sorption chamber. The outside temperature is 77.65° F. and the inside cooling chamber is 36.70° F. At the onset it appears that the sorption-cooling device can establish and maintain the correct hypothermic temperature of biological samples.

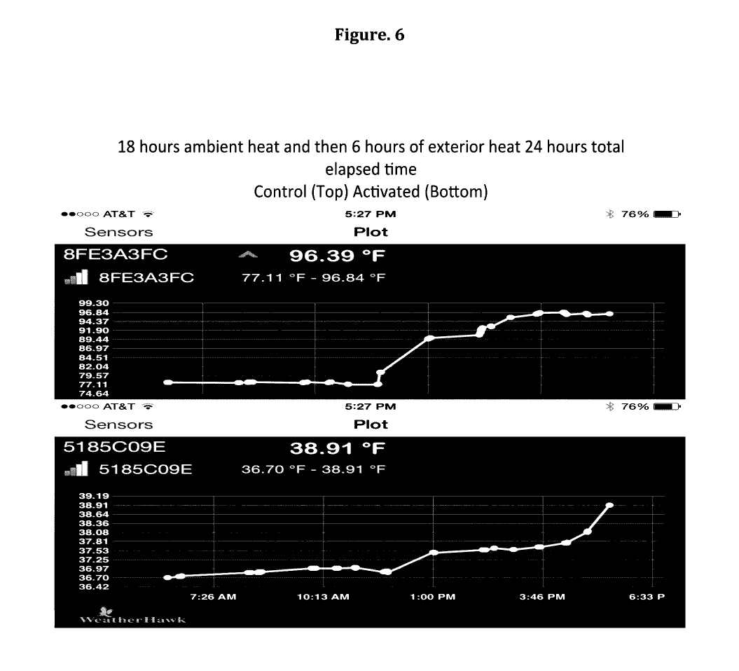

FIG. 6 shows a comparison of the shipping box after 18 hours at room temperature (ambient conditions outside of the package) and then exposed to an outside temperature of 96.39° F. for 6 hours. The top image shows the outside temperature and the bottom image the cooling chamber temperature under the same conditions. As can be seen from the data even though the ambient conditions were extreme the cooling chamber where the biologic simulation was being monitored only rose to 38.91° F. well below hypothermic conditions that is generally considered to be 50° F. The total duration of the test at this point was 24 hours.

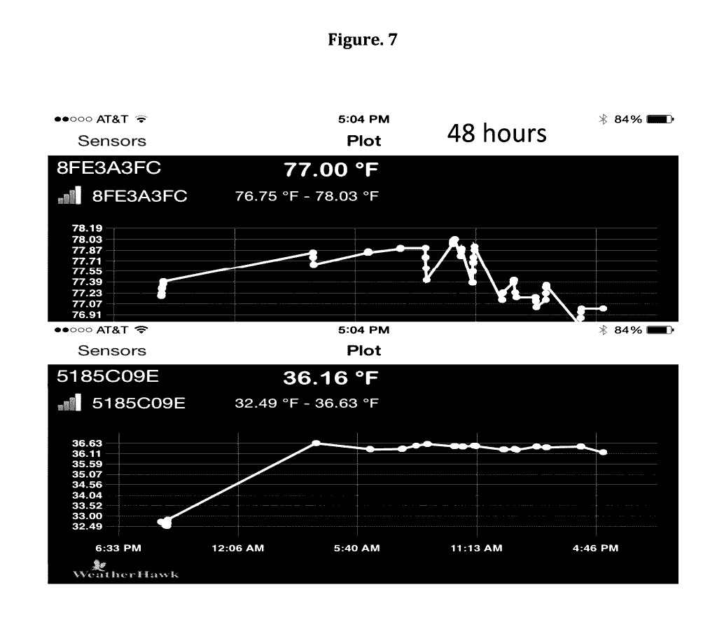

FIG. 7 shows the data after the biologic simulation for 48 hours. As you can see from the data that the ambient temperature has averaged 77° F. top image while the bottom image shows the internal temperature was maintained hypothermic at 36.16° F. during the period from 24 to 48 hours of testing.

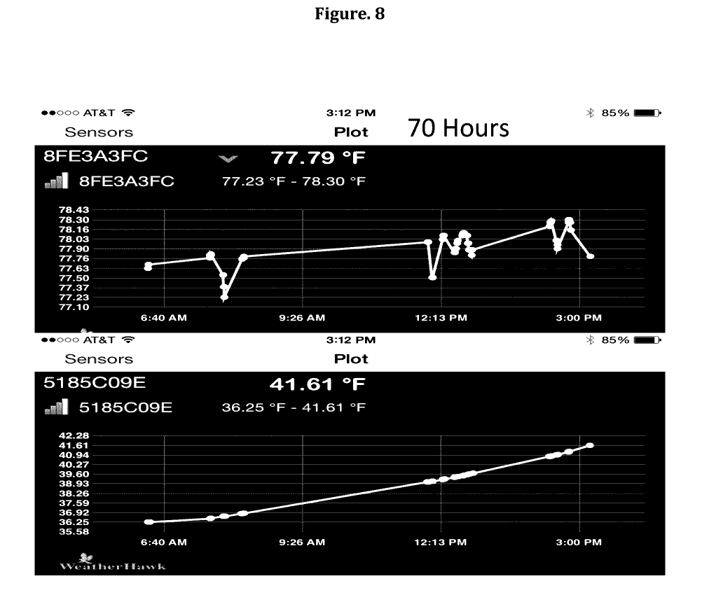

FIG. 8 shows the test results after 70 hours. The top image showing the outside ambient conditions at 77.79° F. and the internal final storage temperature after 70 hours of testing rising to 41.61° F. The testing was stopped after 70 hours because it was determined that the sorption cooling device was adequate for shipping cells, such as iPSc and differentiated cells, anywhere in the world by using express carriers.

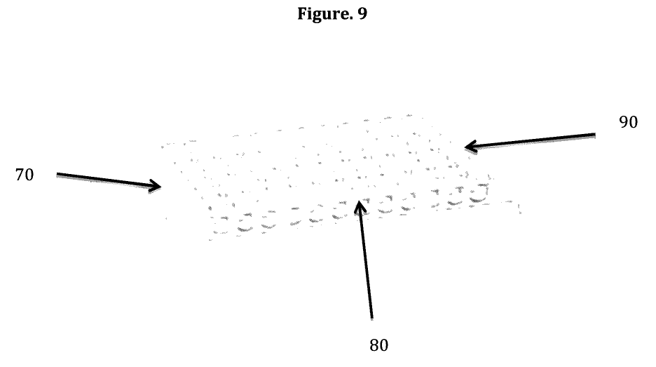

FIG. 9 shows a typical biologic microplate that can be utilized with the present disclosure. It is generally an n×n array of wells and in one embodiment 34 in total. The well plate 70 is generally molded of typical thermoplastic polymers. The wells 80 contain biological material such as cells and in one embodiment iPSc or cells differentiated into various human organ cells. A lid 90 is placed over the wells to contain the cells and liquid nutrient media from spilling during shipping and handling. The lid sealing material is in one embodiment a water barrier but allows for the exchange of gasses such as oxygen and carbon dioxide so that the living cells can carry on respiration during hypothermic shipping and handling.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of preparing living cells for packaging and distribution, comprising:
providing a receptacle having a compartment, wherein at least a portion of the compartment comprises an insulating material having a predefined thickness and predefined thermal conductivity which can maintain a temperature of about 1° C. to about 10° C. for at least 24 hours in the compartment;
providing a sorption device which comprises a passive heat absorbing material;
providing at least one cell culture substrate having living cells in media;
activating the sorption device;
placing the cell culture substrate and the sorption-cooling device in proximity in the compartment of the receptacle; and
sealing the receptacle to allow for a temperature of about 1° C. to about 10° C. for at least 24 hours in the compartment.

2. The method of claim 1 wherein the cells are iPSc.

3. The method of claim 1 wherein the cells are differentiated iPSc.

4. The method of claim 1 wherein the insulating material can maintain a temperature of about 4° C. to about 10° C. for at least 24 hours.

5. The method of claim 4 wherein the temperature is maintained for at least 96 hours.

6. The method of claim 1 wherein the substrate is a multiwell plate.

7. The method of claim 1 further comprising covering the substrate with a lid so as to provide a water-proof barrier.

8. The method of claim 1 wherein the compartment in the receptacle has a temperature of about 4° C. to about 10° C. 24 hours after sealing.

9. The method of claim 1 wherein the compartment further comprises a temperature sensor.

10. The method of claim 1 wherein the cells have a viability of at least 25% up to at least 90% 24 hours after sealing.

11. The method of claim 1 wherein the cells have a viability of at least 25% up to at least 90% 96 hours after sealing.

12. The method of claim 2 wherein at least 25% up to at least 90% of the cells are capable of differentiation 24 to 96 hours after sealing.

13. The method of claim 1 wherein the sorption device absorbs heat so that the temperature in the compartment is about 1° C. to about 10° C.

14. The method of claim 1 wherein the volume of the compartment provides for adequate oxygen during distribution.

15. The method of claim 14 wherein a plurality of cell culture substrates are placed in the compartment.

16. The method of claim 15 wherein different types of cells are in each substrate.

17. The method of claim 1 wherein the seal provides a water-proof barrier.

18. The method of claim 1 wherein the seal provides a barrier that prevents or inhibits oxygen exchange.
